(19) United States
(12) Patent Application Publication
(10) Pub. No.: US 2015/0049023 A1
(43) Pub. Date: Feb. 19, 2015

(54) Keyboard Camera Device

(71) Applicant: OmniVision Technologies, Inc., Santa Clara, CA (US)

(72) Inventors: Raymond Wu, Milpites, CA (US); Kuochin Chang, Cupertino, CA (US); Yalei Mao, Morgan Hill, CA (US)

(73) Assignee: OmniVision Technologies, Inc., Santa Clara, CA (US)

(21) Appl. No.: 13/969,407

(22) Filed: Aug. 16, 2013

(51) Int. Cl. G06F 3/023

(52) U.S. Cl. CPC G06F 3/023
USPC 345/168

(57) ABSTRACT

A keyboard camera device has a key array forming a keyboard and at least one camera configured with the keyboard and positioned with a field of view to view a user of the keyboard. An interface unit includes a keyboard controller for interfacing with an array of keys of the keyboard to detect key operations, a camera controller for controlling the at least one camera to capture images, and a host interface for receiving indication of the key operations and the images and for communicating the key operation indications and the images to one communication port of a computer.

### BACKGROUND

Laptop, notebook, and desktop computers have a keyboard and typically include a camera built into a display device (e.g., LCD screen) of the computer. Such cameras typically have their own interface requiring connectivity (separate from the keyboard connectivity) to the motherboard. FIG. 1 shows a functional diagram of a computer 103 which may include a keyboard 105 and camera 109 coupled with a motherboard 102. In particular, the keyboard has a keyboard controller 106 that (a) couples with a key array 108 to detect key presses and releases and (b) couples with a first USB port 104(1) on a motherboard 102 of computer 103. Camera 109 includes an image sensor 112 that couples with a camera controller 110 that couples with a second USB port 104(2) of motherboard 102. Two USB ports are thus required to simultaneously couple keyboard 105 and camera 109 to computer 103. Where computer 103 is a laptop or notebook type computer and camera 109 is positioned within a screen of that computer, the space available within the screen forces shape and size constraints upon camera controller 110 and image sensor 112, and requires a connector to run from camera controller 110 (typically positioned at a top edge of the screen) to motherboard 102 located in a base. Such connection also typically runs through a hinge between the screen to the base.

### SUMMARY

In one embodiment, a keyboard camera device has a key array forming a keyboard and at least one camera configured with the keyboard and positioned with a field of view to view a user of the keyboard.

In another embodiment, an interface unit controls a keyboard and at least one camera. The interface unit includes a keyboard controller for interfacing with an array of keys of the keyboard to detect key operations, a camera controller for controlling the at least one camera to capture images, and a host interface for receiving indication of the key operations and the images and for communicating the key operation indications and the images to one communication port of a computer.

In another embodiment, a keyboard improvement includes at least one camera configured with the keyboard and positioned with a field of view of view a user of the keyboard.

In another embodiment, a method interfaces a keyboard camera device to a computer. Operation of keys of a keyboard is detected within an interface unit. At least one camera is controlled to capture images within the interface unit. Indication of the key operations and the images is sent from the interface unit to a single port of the computer.

### BRIEF DESCRIPTION OF THE FIGURES

FIG. 1 shows a functional diagram of a computer with keyboard and camera coupled with a motherboard.

FIG. 2 shows one exemplary keyboard camera device, in an embodiment.

FIG. 3 is a top view showing the keyboard camera device of FIG. 2 configured with two cameras positioned between keys of the key array, in an embodiment.

FIG. 4 is a top view showing the keyboard camera device of FIG. 2 configured with two cameras positioned within two keys of the key array, in an embodiment.

FIG. 5A is a cross section through one key of the key array showing one camera within the key, in an embodiment.

FIG. 5B is a cross section through one key of the key array showing two cameras within one key, in an embodiment.

FIG. 6 is a cross-sectional side view showing one exemplary pop-up camera for use within the keyboard camera device of FIG. 2, in an embodiment.

FIG. 7 shows two exemplary pop-up cameras of FIG. 6 positioned within the keyboard camera device of FIG. 2, in an embodiment.

FIG. 8 shows a user interacting with the keyboard camera device of FIG. 2, in an embodiment.

FIG. 9 shows one exemplary method for interfacing the keyboard camera device of FIG. 2 to a computer, in an embodiment.

FIG. 10 shows one exemplary keyboard camera device for use within a computer, in an embodiment.

### DETAILED DESCRIPTION OF THE EMBODIMENTS

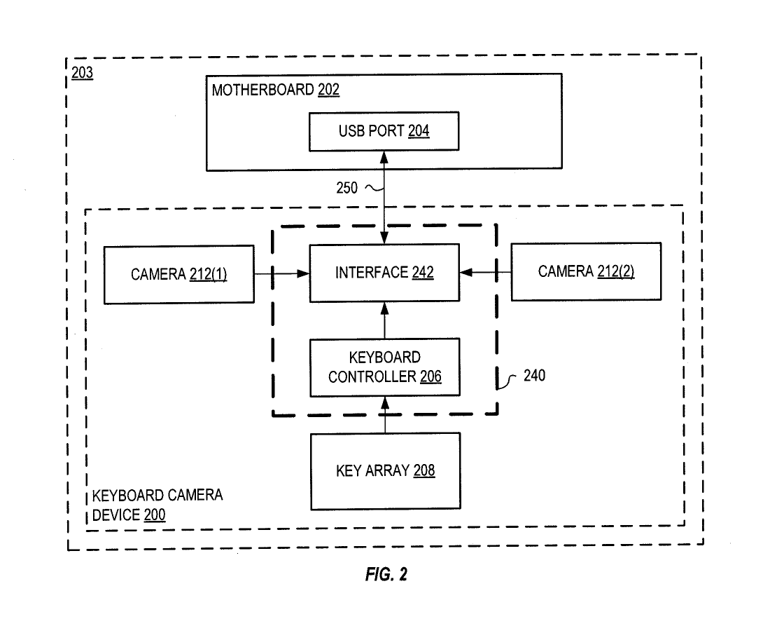

FIG. 2 shows one exemplary keyboard camera device 200 for use within a computer 203. Device 200 is shown with two cameras 212(1) and 212(2), a keyboard controller 206, a key array 208 forming a keyboard, and an interface 242. Each camera 212 has an image sensor and at least one lens for example. Key array 208 may also represent a part of a full keyboard, such as a group of keys thereof, or may represent a smaller keypad for example. Device 200 may include more or fewer cameras 212 without departing from the scope hereof. Keyboard controller 206 operates as a keyboard controller to detect key operation (e.g., key press and key release) of key array 208. Interface 242 couples with keyboard controller 206, each camera 212 and, via communication path 250, with one USB port 204 of a motherboard 202. In one example of operation, interface 242 receives key operation indications from keyboard controller 206 and continuously and/or periodically captures images using cameras 212, and sends these key operation indications and images to USB port 204 of motherboard 202 via communication path 250.

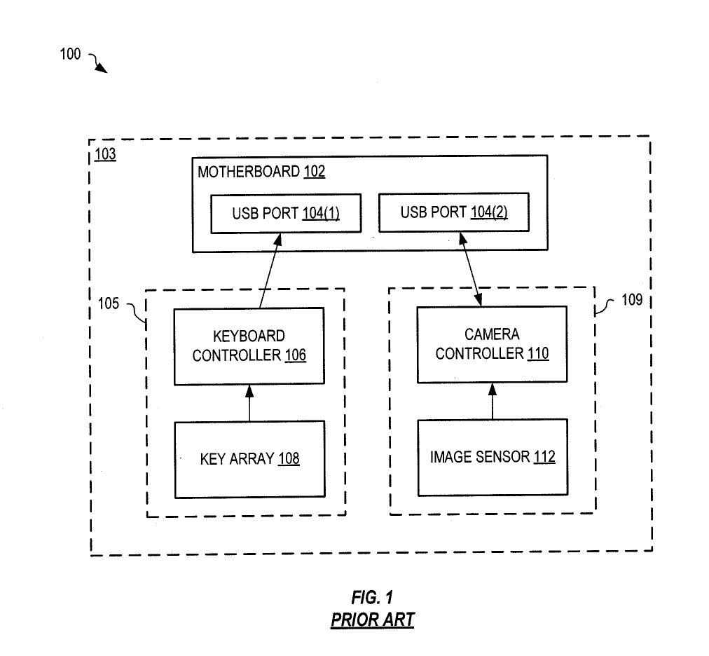

In one embodiment, interface 242 and keyboard controller 206 are implemented as two separate chips. In another embodiment, interface 242 and keyboard controller 206 are integrated within a single interface chip 240, thereby reducing manufacturing cost of device 200 as compared to prior art system 100. Further, device 200 utilizes only a single USB port 204 of motherboard 202, as compared to the two ports 104 used within prior art system 100, FIG. 1.

Interface 242 includes camera controller functionality for simultaneously controlling and operating each camera 212 to capture either a single stereo video stream or two separate video streams, where each video stream comprises a plurality of images. In one example of operation, device 200 captures stereo images of gestures made above device 200, thereby enabling gesture input to computer 203. Device 200 may thereby eliminate the need for a touch pad, as commonly found on prior art computers, particularly on notebook and laptop computers.

By incorporating interface 242 and keyboard controller 206 within a single interface chip 240, integration of cameras 212 and a keyboard within computer 203 is simplified and cost of computer 203 is reduced, particularly where computer 203 is a notebook or laptop style computer. Although gesture input is used as an exemplary use of device 200, device 200 may also be used to capture conventional images, such as for scanning, face and pattern recognition, video conferencing, and so on. By incorporating cameras 212 with key array 208, input functionality of the device is increased.

FIG. 3 is a top view showing keyboard camera device 200 of FIG. 2 configured with two cameras 212 positioned between keys of key array 208. In this embodiment, cameras 212 are positioned adjacent to arrow keys 302 of key array 208 and have a field of view that is substantially perpendicular to the plane of key array 208. However, cameras 212 may be positioned adjacent to other keys and within other spaces around key array 208 without departing from the scope hereof. In one embodiment, the field of view is defined by an aperture in a surface structure 304 of device 200, wherein cameras 212 are positioned beneath surface structure 304 and behind the aperture.

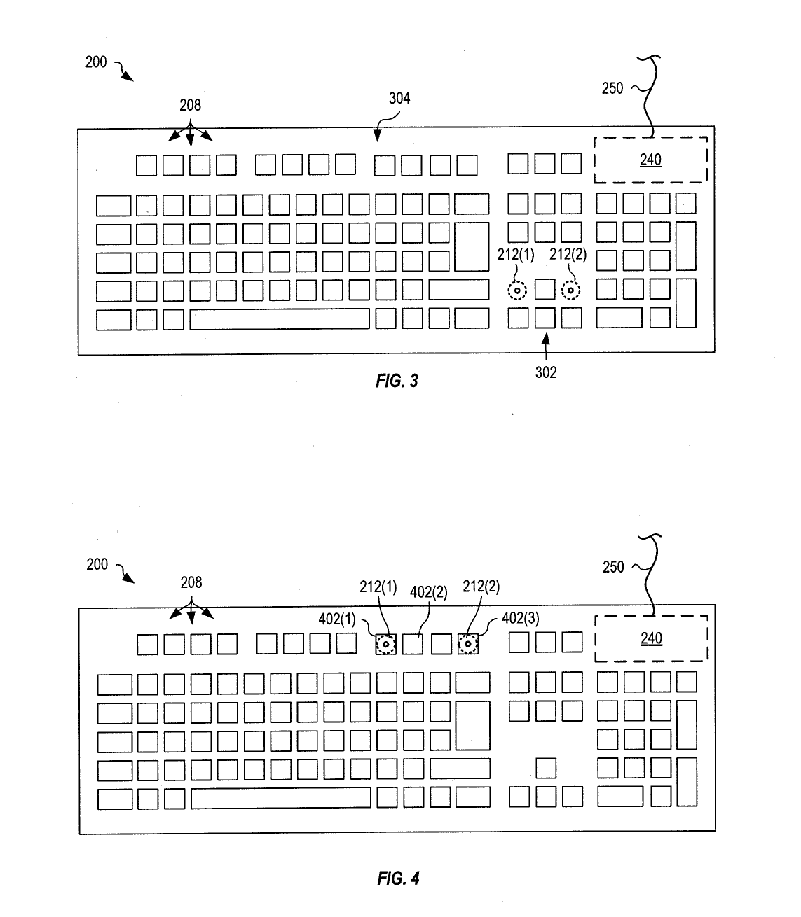

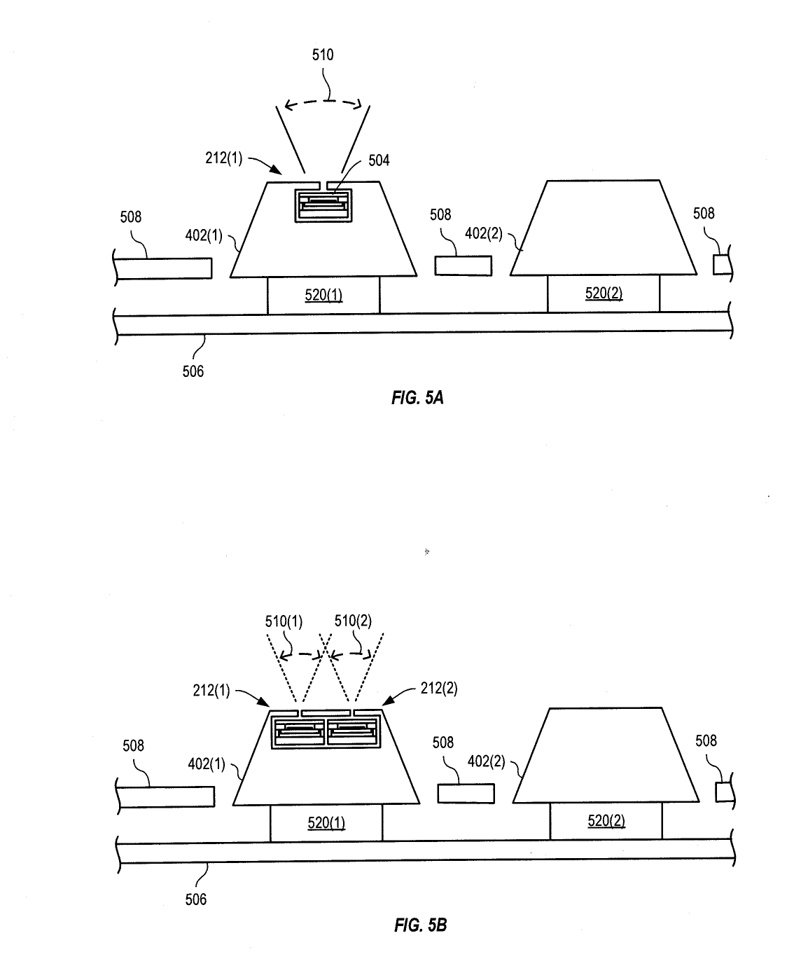

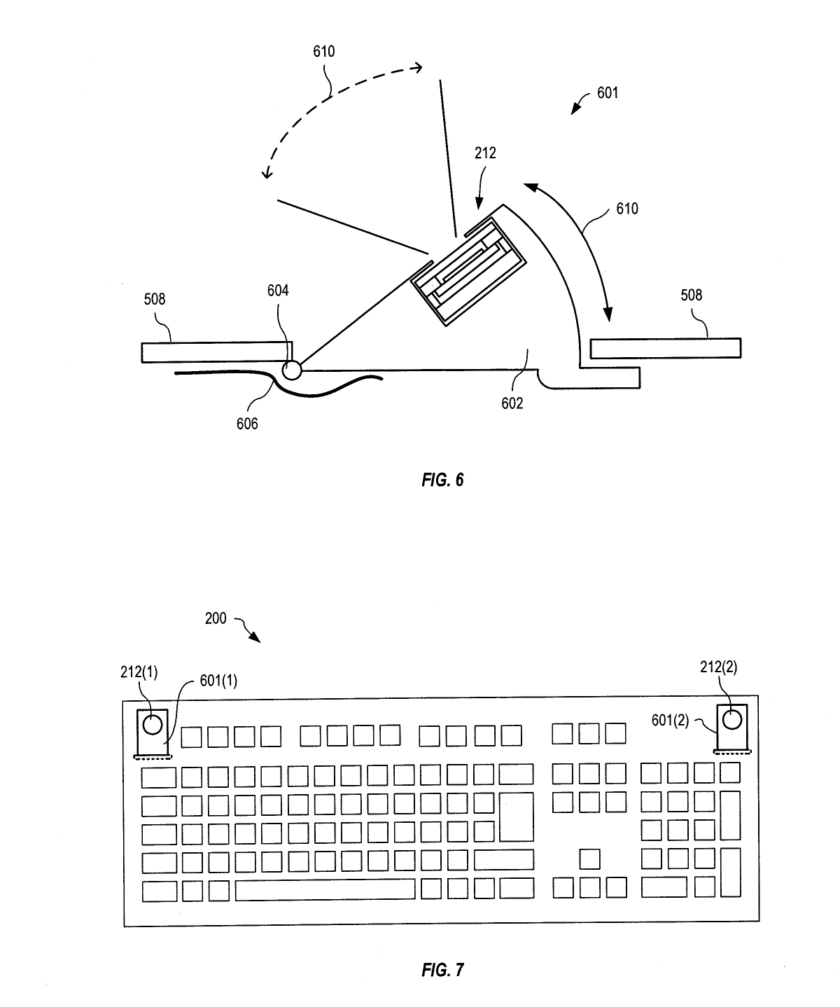

FIG. 4 is a top view showing keyboard camera device 200 of FIG. 2 configured with two cameras 212 positioned within two keys of key array 208. On conventional keyboards, many function keys (e.g., F5-F12) are seldom used and therefore make ideal keys choices to include cameras 212. In the embodiment of FIG. 4, camera 212(1) is configured with key 402(1) and camera 212(2) is configured with key 402(3). FIG. 5A is a cross section through keys 402(1) and 402(2) of key array 208 showing camera 212(1). Camera 212(1) may be configured as a flip chip within the key. FIG. 5B is a cross section through keys 402(1) and 402(2) of key array 208 showing two cameras 212(1), 212(2) within one key. More cameras may be included in each key without departing from the scope hereof. The position and orientation of each camera 212 within key 402(1) is selected based upon a desired field of view 510 for the camera. FIGS. 4, 5A and 5B are best viewed together with the following description.

Keys 402(1) and 402(2) may be supported by components 520(1) and 520(2) mounted on a substrate 506, such that keys 402 protrude through apertures within a surface structure 508 of computer 203 for example. Optionally, surface structure 508 may form part of device 200. Components 520 may allow keys 402 to be depressed and also to detect operation (e.g., key press and key release) of keys 402 by the user. Components 520 may couple electrically with substrate 506 to provide signals indicative of such key operations. For example, component 520(1) allows key 402(1) to be depressed by a user, wherein an electrical characteristic is changed on substrate 506. That is, key 402(1) still functions as a key of key array 208. Component 520(1) further includes connectivity between camera 212(1) and substrate 506, wherein substrate 506 couples with single interface chip 240 such that key operations are detected by keyboard controller 206 and camera 212(1) coupled with interface 242.

In an alternate embodiment, keys 402 cannot be depressed. However, when interface 242 detects that camera 212(1) is covered by a finger of the user, interface 242 may generate a key press signal indicative of the key position occupied by camera 212(1) and generate a key release signal when the finger is removed from the surface of the key.

Camera 212(1) has a field of view 510 selected by the position of camera 212(1) within key 402(1) and lens 504 of camera 121 for example. Camera 212 may be positioned at an angle relative to key 402 such that field of view 510 is less perpendicular to key array 208. Electrical connectivity between camera 212(1) and interface 242 is not shown for clarity of illustration, but is for example made through component 520(1) to substrate 506, where substrate 506 has a plurality of electrical tracks that connect between components 520, cameras 212 and interface 242. Substrate 506 is for example one of a circuit board and/or a flex circuit.

FIG. 6 is a cross-sectional side view showing one exemplary pop-up camera 601 for use within keyboard camera device 200 of FIG. 2. Pop-up camera 601 has a mechanism for allowing camera 212 to “pop-up” relative to key array 208 such that it protrudes through an aperture in, and above the surface of, surface structure 508. In the example of FIG. 6, pop-up camera 601 has a structural component 602 that couples to surface 508 via a hinge 604 and a spring clip 606 that cooperate to push pop-up camera 601 through the aperture within surface structure 508 when the screen of computer 203 (e.g., a notebook) is opened and allows component 602 to descend below surface 508 when the screen is closed. Orientation of hinge 604, size and shape of component 602, and orientation of camera 212 may be selected based upon a desired field of view 610 of camera 212. For example, each of cameras 212(1) and 212(2) may be oriented such that during normal operation (e.g., upon opening the screen of computer 203) field of view 610 of each camera 212 face towards a user of computer 203. However, other orientations of pop-up camera 601, camera 212, component 606, and hinge 604 may be used without departing from the scope hereof. Other mechanisms for allowing camera 212 to pop-up from the plane of key array 208 may be used without departing from the scope hereof.

FIG. 7 shows two exemplary pop-up cameras 601(1) and 601(2) of FIG. 6 positioned within keyboard camera device 200 of FIG. 2 to capture stereo images, in an embodiment. When pop-up cameras 601 are in their popped-up position the simultaneously capture images that combine as the stereo images of the user of keyboard camera device 200. These stereo images may be used to determine gestures of the user to control one or more aspects of computer 203. For example, the stereo images may be used to: control a mouse pointer on a screen of computer 203, move desktop application icons, flip Windows pages, turn on speakers, and to enter other commands to computer 203.

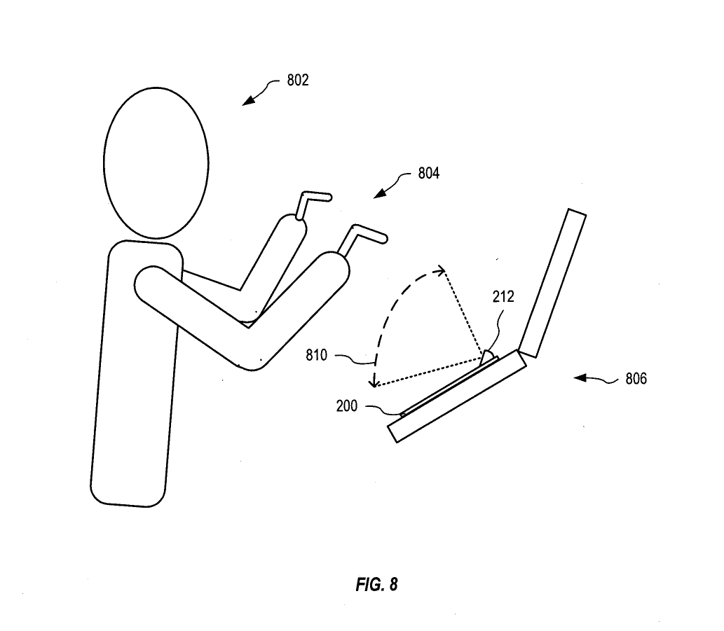

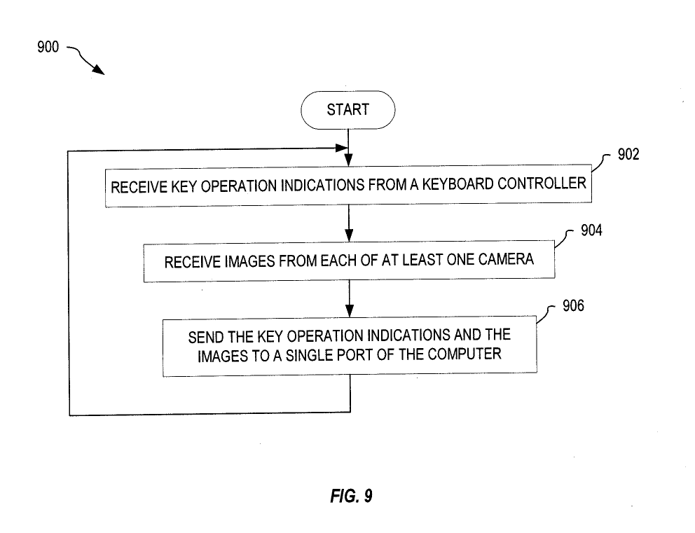

FIG. 8 shows a user 802 interacting with keyboard camera device 200 of FIG. 2. Keyboard camera device 200 is incorporated into a notebook computer 806, thereby allowing user 802 to make gestures 804 that are captured by one or more cameras 212 of device 200. Camera 212 is positioned such that field of view 810 includes at least part of user 802.

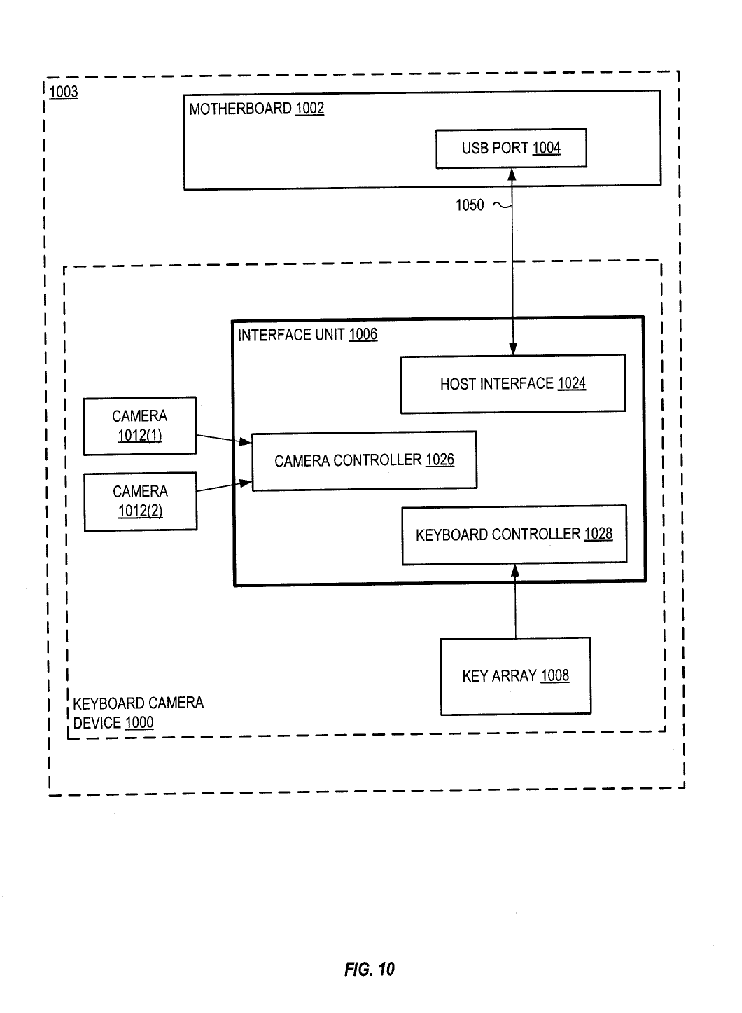

FIG. 9 shows one exemplary method 900 for interfacing keyboard camera device 200 of FIG. 2 to a computer. Method 900 is for example implemented within interface 242 of keyboard camera device 200 and/or interface unit 1006 of keyboard camera device 1000, FIG. 10. In step 902, method 900 receives key operation indications from a keyboard controller. In one example of step 902, interface 242 receives key operation indications from keyboard controller 206. In step 904, method 900 receives images from each of at least one camera. In one example of step 904, interface 242 receives an image from each camera 212. In step 906, method 900 sends the key operation indications and the images to a single port of the computer. In one example of step 906, interface 242 sends the key operation indications and the images to a single port of computer 203. Steps 902 through 906 repeat.

FIG. 10 shows one exemplary keyboard camera device 1000 for use within a computer 1003. Device 1000 is shown with two cameras 1012(1) and 1012(2), an interface unit 1006, and a key array 208 forming a keyboard. Each camera 1012 has an image sensor and at least one lens for example. Key array 1008 may also represent a part of a full keyboard, such as a group of keys thereof, or may represent a smaller keypad for example. Device 1000 may include more or fewer cameras 1012 without departing from the scope hereof. Interface unit 1006 includes a host interface 1024, a camera controller 1026, and a keyboard controller 1028. Host interface 1024 interfaces with a USB port 1004 on a motherboard 1002 of computer 1003 for example. Camera controller 1026 communicates with and controls cameras 1012 to capture images. Keyboard controller 1028 detects key operations (e.g., key press and key release) of key array 208. Host interface 1024 receives images from camera controller 1026 and key operation indications from keyboard controller 1028, and sends these images and key operation indications to motherboard 1002 via communication link 1050 and USB port 1004. In one example of operation, host interface 1024 receives key operation indications from keyboard controller 1028. Camera controller 1026 continuously and/or periodically captures images using cameras 1012. Host interface 1024 receives the images from camera controller 1026 and key operation indications from keyboard controller 1028 and sends these images and key operation indications to USB port 204 of motherboard 202 via communication path 250.

In one embodiment, interface unit 1006 is implemented as a single interface chip, thereby reducing manufacturing cost of device 1000 as compared to prior art system 100, FIG. 1. Further, device 1000 utilizes only a single USB port 1004 of motherboard 1002, as compared to the two ports 104 used within prior art system 100, FIG. 1.

Camera controller 1026 may operate cameras 212 to capture stereo images. In one example of operation, device 1000 captures stereo images of gestures made above device 1000, thereby enabling gesture input to computer 1003. Device 1000 may thereby eliminate the need for a touch pad, as commonly found on prior art computers, particularly on notebook and laptop computers.

By incorporating host interface 1024, camera controller 1026, and keyboard controller 1028 within interface unit 1006, integration of cameras 1012 and a keyboard (e.g., key array 1008) within computer 1003 is simplified and cost of computer 1003 is reduced, particularly where computer 1003 is a notebook or laptop style computer. Although gesture input is used as an exemplary use of device 1000, device 1000 may also be used to capture conventional images, such as for scanning, video conferencing, and so on. By incorporating cameras 1012 with key array 1008, input functionality of the device is increased.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A keyboard camera device, comprising:
key array forming a keyboard; and
at least one camera configured with the keyboard and positioned with a field of view to view a user of the keyboard.

2. The keyboard camera device of claim 1, wherein the at least one camera is positioned behind an aperture in the keyboard adjacent to keys of the key array.

3. The keyboard camera device of claim 2, wherein the keys are arrow keys of the keyboard.

4. The keyboard camera device of claim 1, further comprising a keyboard controller, coupled with the key array, for detecting key operations.

5. The keyboard camera device of claim 4, further comprising a camera controller for controlling the at least one camera to capture images.

6. The keyboard camera device of claim 5, further comprising an interface for coupling the keyboard controller and the camera controller to a host computer.

7. The keyboard camera device of claim 1, wherein each of the at least one camera is configured within a different key of the key array.

8. The keyboard camera device of claim 1, wherein each of the at least one camera is configured within one key of the key array.

9. The keyboard camera device of claim 1, wherein the at least one camera is positioned with a field of view substantially perpendicular to a plane of keys of the key array.

10. The keyboard camera device of claim 9, wherein the at least one camera is configured with a pop-up mechanism to position the camera above the plane.

11. The keyboard camera device of claim 1, the at least one camera comprising two cameras positioned a distance apart to capture stereo images.

12. The keyboard camera device of claim 11, wherein the stereo images are used to determine gestures of a user of the keyboard camera device.

13. The keyboard camera device of claim 1, wherein the keyboard is a key pad.

14. An interface unit for controlling a keyboard and at least one camera, comprising:
a keyboard controller for interfacing with an array of keys of the keyboard to detect key operations;
a camera controller for controlling the at least one camera to capture images; and
a host interface for receiving indication of the key operations and the images and for communicating the key operation indications and the images to one communication port of a computer.

15. The interface unit of claim 14, wherein the images are stereo images captured from two cameras.

16. The interface unit of claim 15, wherein the stereo images are used for determining one or more of gestures, eye-tracking, 3-D scanning, and face and pattern recognition, of a user of the keyboard for input to the computer.

17. The interface unit of claim 14, wherein the keyboard controller, the camera controller, and the host interface are implemented as a single chip.

18. In a keyboard, the improvement comprising at least one camera configured with the keyboard and positioned with a field of view of view a user of the keyboard.

19. The improvement of claim 18, further comprising a pop-up mechanism to position the camera for viewing a user of the keyboard.

20. The improvement of claim 18, wherein each of the at least one camera is positioned behind an aperture within the keyboard.

21. A method for interfacing a keyboard camera device to a computer, comprising:
detecting, within an interface unit, operation of keys of a keyboard;
controlling, within the interface unit, at least one camera to capture images; and
sending, from the interface unit, indication of the key operations and the images to a single port of the computer.

22. The method of claim 21, wherein the images are stereo images captured from two cameras.

23. The method of claim 22, wherein the stereo images contain one or more of gestures, eye-tracking, 3-D scanning, and face and pattern recognition, for input to the computer.
